(19) United States
(12) Patent Application Publication
(10) Pub. No.: US 2020/0089170 A1
(43) Pub. Date: Mar. 19, 2020

(54) RADIO-CONTROLLED WATCH

(71) Applicant: CITIZEN WATCH CO., LTD., Tokyo (JP)

(72) Inventors: Ken KITAMURA, Nishitokyo-shi, Tokyo (JP); Shuji NAKA, Fuchu-shi, Tokyo (JP); Akira KATO, Tokorozawa-shi, Saitama (JP); Yoshiyasu WATANABE, Koganei-shi, Tokyo (JP)

(21) Appl. No.: 16/493,831

(22) PCT Filed: Mar. 13, 2018
(86) PCT No.: PCT/JP2018/009736

§ 371 Date: Sep. 13, 2019

(30) Foreign Application Priority Data
Mar. 14, 2017 (JP) 2017-048617

(51) Int. Cl. G04G 21/04; G04R 60/10; H01Q 1/27; H01Q 1/38

(52) U.S. Cl. CPC G04G 21/04; H01Q 1/38; H01Q 1/273; G04R 60/10

(57) ABSTRACT

Provided is a highly sensitive radio-controlled watch which includes: a watch glass; a case into which the watch glass is fitted; a movement disposed inside the case; and an antenna body disposed between the watch glass and the movement, and also along an inner periphery of the case, the antenna body including: an antenna electrode; and an antenna base having a surface on which the antenna electrode is disposed, and the antenna base having a permittivity higher than a permittivity of other components around the antenna body.

### TECHNICAL FIELD

The present invention relates to a radio-controlled watch configured to receive a signal from a satellite or the like.

### BACKGROUND ART

A portable radio-controlled watch configured to receive time information contained in a signal transmitted from a satellite, or the like, included in a global positioning system (GPS) to correct the time has been put into practical use. A type and an arrangement of an antenna for receiving radio waves are determined so that required reception sensitivity can be obtained without impairing the function of the watch.

In general, an antenna size is determined in accordance with a target wavelength so as to obtain suitable frequency characteristics. However, when a component layout is limited as in a radio-controlled watch, a suitable antennal length may not be ensured. In such a case, an antenna electrode is disposed on a surface of a dielectric body. A wavelength shortening effect of the dielectric body allows a small antenna to have desired frequency characteristics.

In Patent Literature 1, there is disclosed a wristwatch having a wireless communication function. The wristwatch includes a GPS antenna 11 including a dielectric base 113 and an antenna electrode 114, and a dial ring 110 configured to receive the GPS antenna 11. The antenna electrode 114 is disposed on a surface of the dielectric base 113.

In Patent Literature 2, there is disclosed an electronic watch including an outer case 80 made of, for example, ceramics, a main plate 38 and a dial ring 83, which are made of a nonconductive material, and an antenna body 40. The antenna body 40 includes an annular dielectric body 401 and antenna patterns 402 and 403 formed on a surface of the dielectric body. The antenna body 40 is accommodated in a doughnut-like space surrounded by the main plate 38, the dial ring 83, and the outer case 80.

### CITATION LIST

### Patent Literature

[Patent Literature 1] JP 2012-233926 A

[Patent Literature 2] JP 2014-62852 A

### SUMMARY OF INVENTION

### Technical Problem

Recent trends toward slim radio-controlled watches, for example, cause a difficulty in ensuring a large space between the antenna and surrounding dielectric members. In this regard, when the antenna and the surrounding components are disposed closer to each other, antenna characteristics easily vary due to change in space between the antenna and the surrounding dielectric components. For example, when a radio-controlled watch is deformed by an external force, or has a large manufacturing tolerance, the radio-controlled watch cannot operate with a reception sensitivity initially set.

The present invention has been made in view of the circumstances described above, and it is therefore an object of the present invention to provide a technology of suppressing fluctuations in reception sensitivity of a radio-controlled watch.

### Solution to Problem

(1) a radio-controlled watch including: a watch glass; a case, into which the watch glass is fitted; a movement disposed inside the case; and an antenna body, in which at least a part thereof is disposed between the watch glass and the movement and also along an inner periphery of the case, the antenna body including: an antenna electrode; and an antenna base having a surface on which the antenna electrode is disposed, and the antenna base having a permittivity higher than permittivity of other components around the antenna body.

(2) In the radio-controlled watch of Item (1), the permittivity of the antenna base is higher than the permittivity of other components disposed within a distance equal to or less than 1/20 of a reception wavelength from the antenna body.

(3) In the radio-controlled watch of Item (1) or Item (2), the permittivity of the antenna base is more than twice the permittivity of the other components.

(4) In the radio-controlled watch of any one of Item (1) to Item (3), the permittivity of the antenna base is higher than the permittivity of other components disposed between the watch glass and the movement.

(5) In the radio-controlled watch of any one of Item (1) to Item (4), the permittivity of the antenna base is higher than a permittivity of other components adjacent to the antenna body.

(6) In the radio-controlled watch of any one of Item (1) to Item (5), one of the other components is opposed to at least a part of the antenna electrode.

(7) In the radio-controlled watch of any one of Item (1) to Item (6), the antenna base has a portion closer to another component than the antenna electrode.

(8) In the radio-controlled watch of Item (7), the antenna base has one of a recess and a plurality of protrusions, and wherein the antenna electrode is disposed inside the recess, or disposed adjacent to the plurality of protrusions.

(9) In the radio-controlled watch of Item (7), the radio-controlled watch further includes a protective component disposed on the surface of the antenna base and also around the antenna electrode.

(10) In the radio-controlled watch of Item (7), the another component has one of a recess conforming to a shape of the antenna electrode, and a protrusion opposed to a region around the antenna electrode, of a surface of the antenna base.

(11) In the radio-controlled watch of any one of Item (1) to Item (10), the radio-controlled watch further includes a protective component having elasticity, the component being disposed on the movement side of the antenna body.

(12) In the radio-controlled watch of any one of Items (1) to Item (11), the radio-controlled watch further includes: a dial trim ring disposed between the watch glass and the movement, the antenna body being disposed between the dial trim ring and the watch glass.

(13) In the radio-controlled watch of Item (12), the dial trim ring has a recess in a surface thereof on the watch glass side, and the antenna body is disposed in the recess.

(14) In the radio-controlled watch of any one of Items (1) to Item (13), the other components include a dial trim ring disposed between the watch glass and the movement, the watch glass, a dial disposed between the watch glass and the movement, the case, and the movement, and wherein the dial trim ring is closer to the watch glass than the antenna body.

### Advantageous Effects of Invention

According to the present invention, fluctuations in the reception sensitivity of the radio-controlled watch can be suppressed.

### BRIEF DESCRIPTION OF DRAWINGS

FIG. 1 is a plan view for illustrating one example of a satellite radio-controlled wristwatch according to an embodiment of the present invention.

FIG. 2 is a sectional view taken along the line II-II of the satellite radio-controlled wristwatch illustrated in FIG. 1.

FIG. 3 is a block diagram for illustrating a schematic circuit configuration of the satellite radio-controlled wristwatch.

FIG. 4 is a partial sectional view for schematically illustrating one example of how to connect an antenna electrode and a conductive pin.

FIG. 5 is a partial sectional view for schematically illustrating another example of how to connect the antenna electrode and the conductive pin.

FIG. 6 is an explanatory view for illustrating a change in distance between the antenna electrode and a high dielectric component.

FIG. 7 is an explanatory view for illustrating a change in distance between the antenna electrode and the high dielectric component.

FIG. 8 is a graph for showing variation in frequency characteristics of the antenna electrode on a dielectric body having a permittivity of 3.

FIG. 9 is a graph for showing variation in frequency characteristics of the antenna electrode on a dielectric body having a permittivity of 10.

FIG. 10 is a graph for showing variation in frequency characteristics of the antenna electrode on a dielectric body having a permittivity of 33.

FIG. 11 is a graph for showing variation in frequency characteristics of an antenna electrode on a dielectric body having a permittivity of about 90.

FIG. 12 is a graph for showing a relationship between a permittivity and variation in frequency characteristics.

FIG. 13 is a partial sectional view for illustrating another example of the satellite radio-controlled wristwatch.

FIG. 14 is a partial sectional view for illustrating another example of the satellite radio-controlled wristwatch.

FIG. 15 is a partial sectional view for illustrating another example of the satellite radio-controlled wristwatch.

FIG. 16 is a partial sectional view for illustrating another example of the satellite radio-controlled wristwatch.

FIG. 17 is a partial sectional view for schematically illustrating an other example of an antenna body and watch glass.

FIG. 18 is a partial sectional view for illustrating an example of how the antenna body and the watch glass of FIG. 17 come close to each other.

FIG. 19 is a view for schematically illustrating an example of how to connect the antenna body and the conductive pin.

FIG. 20 is a partial sectional view for illustrating another example of the antenna body.

FIG. 21 is a partial sectional view for illustrating another example of the antenna body.

FIG. 22 is a partial sectional view for illustrating another example of the antenna body and a component opposed to the antenna body.

FIG. 23 is a partial sectional view for illustrating another example of the antenna body and the component opposed to the antenna body.

FIG. 24 is a partial sectional view for illustrating another example of the satellite radio-controlled wristwatch.

FIG. 25 is a partial sectional view for illustrating another example of the satellite radio-controlled wristwatch.

FIG. 26 is a partial sectional view for illustrating another example of the satellite radio-controlled wristwatch.

FIG. 27 is a partial sectional view for illustrating another example of the satellite radio-controlled wristwatch.

FIG. 28 is a partial sectional view for illustrating another example of the satellite radio-controlled wristwatch.

FIG. 29 is a partial sectional view for illustrating another example of the satellite radio-controlled wristwatch.

FIG. 30 is a partial sectional view for illustrating another example of the satellite radio-controlled wristwatch.

FIG. 31 is a partial sectional view for illustrating another example of the satellite radio-controlled wristwatch.

### DESCRIPTION OF EMBODIMENTS

Now, an embodiment of the present invention is described in detail with reference to the drawings. In the following, a satellite radio-controlled wristwatch 1 according to the embodiment of the present invention is described. The satellite radio-controlled wristwatch 1 according to this embodiment is configured to receive satellite radio waves including time information, and measure its position or correct the time counted by itself with use of the time information included in the received satellite radio waves.

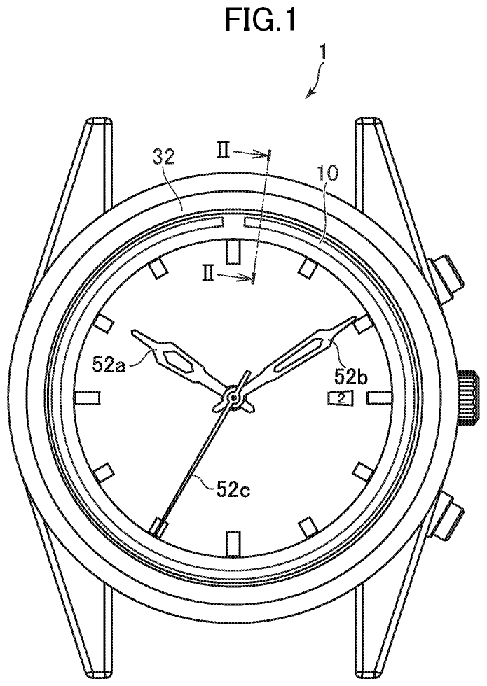

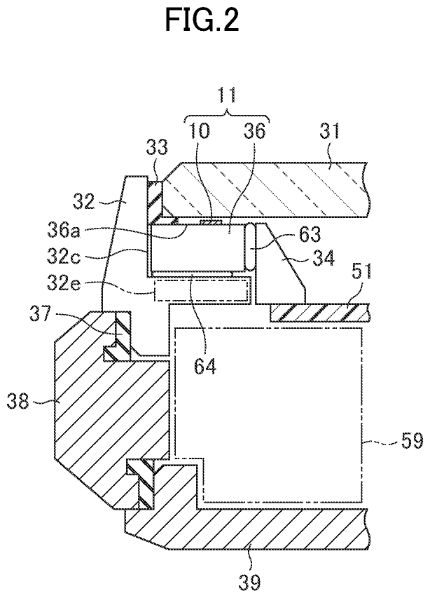

FIG. 1 is a plan view for illustrating one example of the satellite radio-controlled wristwatch 1 according to the embodiment of the present invention, and FIG. 2 is a sectional view taken along the line II-II of the satellite radio-controlled wristwatch 1 illustrated in FIG. 1. As illustrated in FIG. 1 and FIG. 2, the satellite radio-controlled wristwatch 1 includes a watch glass 31, a bezel 32 for holding the watch glass 31, a cylindrical case body 38, and a back cover 39 mounted below the case body 38. Those components form an outer shape of the satellite radio-controlled wristwatch 1. The case body 38 and the bezel 32 are sandwiched between the watch glass 31 and the back cover 39. The case body 38, the bezel 32, and the back cover 39 form an outer case of the satellite radio-controlled wristwatch 1. In the following, a direction from the back cover 39 of the satellite radio-controlled wristwatch 1 to the watch glass 31 and a direction from the watch glass 31 to the back cover 39 are referred to as upward and downward, respectively.

The case body 38 is made of metal and has a hole passing in an up-down direction. The bezel 32 is a ring-shaped component that conforms to a shape of an upper end of the hole of the case body 38. The bezel 32 is made of metal or ceramics. The bezel 32 is fitted to the upper end of the hole of the case body 38, and thus connected to the case body 38. Further, the back cover 39 is made of metal and has a flat surface that conforms to a lower end of the hole of the case body 38. The back cover 39 is fitted to the lower end of the hole. The watch glass 31 is, for example, sapphire glass having a permittivity of about 10. The watch glass 31 has a flat shape that conforms to a shape of an upper end of an opening of the bezel 32. The watch glass 31 is fitted to the opening of the bezel 32. The watch glass 31 and the bezel 32 are in contact with each other via a packing 33, and the watch glass 31 is securely held by the packing 33. Moreover, the bezel 32 and the case body 38 are in contact with each other through a packing 37, and the bezel 32 is securely held by the packing 37. In this regard, the watch glass 31 may be fixed to the bezel 32 by, for example, caulking or bonding instead of being fixed by the packing 33, although the fixation by caulking or bonding is inferior in impact resistance and waterproofness.

Further, the satellite radio-controlled wristwatch 1 includes an antenna body 11, a ring-shaped dial trim ring 34, a dial 51, an hour hand 52a, a minute hand 52b, a second hand 52c, a solar cell (not shown), and a movement 59. Those components are arranged in a space surrounded by the watch glass 31, the bezel 32, the case body 38, and the back cover 39. The dial trim ring 34 is made of plastics. The movement 59 is disposed inside the outer case, and includes a calendar, a main plate, a circuit board, and a drive circuit, for example. The antenna body 11 includes an antenna electrode 10 and a high dielectric component 36. The high dielectric component 36 is, for example, a dielectric body containing ceramics such as zirconia. The high dielectric body has a permittivity higher than those of the surrounding components. For example, when the watch glass 31 is sapphire glass having a permittivity of 10, it is desirable for the dielectric body to have a permittivity twice higher than that of the sapphire glass, i.e., a permittivity of 20 or more.

The dial trim ring 34 is disposed between the watch glass 31 and the movement 59, and particularly in an example illustrated in FIG. 2, the dial trim ring 34 is disposed between the dial 51 and the watch glass 31. Further, in the illustrated example of FIG. 2, the antenna body 11 is a ring-shaped component, and is disposed between the dial trim ring 34 and an inner peripheral surface 32c of the bezel 32 that forms the outer case. The antenna body 11 is, in plan view, disposed along the inner peripheral surface 32c of the bezel 32 that forms the outer case. Further, the bezel 32 has a protruding portion 32e that protrudes radially inward from a lower end of the inner peripheral surface 32c. The high dielectric component 36 is disposed between the protruding portion 32e of the bezel 32 and the watch glass 31. A cushioning component 63 is provided between the high dielectric component 36 and the dial trim ring 34, and a cushioning component 64 is provided between the high dielectric component 36 and the protruding portion 32e.

The antenna electrode 10 is an arc-shaped electrode. The electrode is disposed on an upper surface 36a of the high dielectric component 36 so as to extend along a peripheral edge of the watch glass 31 and an outer periphery of the dial 51. The antenna electrode 10 on the high dielectric component 36 may be formed by bonding a metal element onto the high dielectric component 36, or formed through vapor deposition or laser direct structuring (LDS). Note that, the antenna electrode 10 may not be necessarily disposed on the upper surface 36a of the high dielectric component 36. For example, the antenna electrode 10 may be disposed on a lower or side surface of the high dielectric component 36. In addition, when the high dielectric component 36 has an inclined surface relative to the dial 51, the antenna electrode 10 may be disposed on the inclined surface. Moreover, the antenna electrode 10 may not be disposed on a flat surface. For example, the antenna electrode 10 may be formed to curve along a recess formed in the surface of the high dielectric component 36 as well as to cover the recess. The antenna electrode 10 is adjacent to the watch glass 31. The antenna electrode 10 may be formed as a linear antenna with use of a linear electrode.

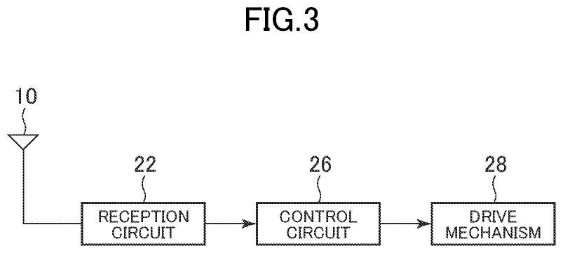

FIG. 3 is a block diagram for illustrating a schematic circuit configuration of the satellite radio-controlled wristwatch 1. The satellite radio-controlled wristwatch 1 further includes a reception circuit 22, a control circuit 26, and a drive mechanism 28. A signal received by the antenna electrode 10 is input to the reception circuit 22 via a signal line.

The reception circuit 22 decodes the signals received by the antenna electrode 10 to output a bit string (reception data) indicating the details of a satellite signal obtained as a result of decoding. More specifically, the reception circuit 22 includes a high frequency circuit (RF circuit) and a decoder circuit. The high frequency circuit operates at a high frequency to amplify and detect the analog signals received by the antenna electrode 10 and convert the signals to a baseband signal. The decoder circuit decodes the baseband signal output from the high frequency circuit, and generates a bit string indicating the details of the data received from the GPS satellite to output the bit string to a control circuit 26.

The control circuit 26 is a circuit configured to control various circuits and mechanisms included in the satellite radio-controlled wristwatch 1, and includes, for example, a microcomputer, a motor drive circuit, and a real time clock (RTC). The control circuit 26 acquires time based on the reception data or a clock output by the RTC to drive the motor included in the drive mechanism 28 in accordance with the acquired time. The drive mechanism 28 includes the motor being a stepper motor and a gear train. The gear train transmits the rotation of the motor to rotate any one of the hour hand 52a, the minute hand 52b, and the second hand 52c, for example. The current time is indicated in this manner.

Note that, when the antenna electrode 10 has balanced antenna characteristics, a balun circuit may be provided between the antenna electrode 10 and the reception circuit 22.

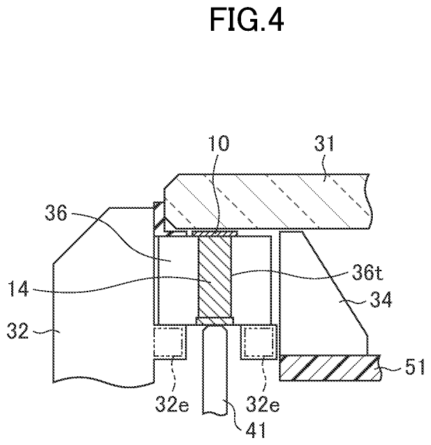

FIG. 4 is a partial sectional view for schematically illustrating one example of how to connect the antenna electrode 10 and a conductive pin 41. The high dielectric component 36 has a through-hole 36t passing in an up-down direction, directly below an end portion of the antenna electrode 10. A signal line used to electrically connect between the antenna electrode 10 and the reception circuit 22 includes the conductive pin 41 and a connection wiring 14 used to electrically connect the antenna electrode 10 and the conductive pin 41. In an example illustrated in FIG. 4, the connection wiring 14 is a metal component filled into the through-hole 36t. An upper end of the connection wiring 14 is in contact with the antenna electrode 10, and a lower end thereof is in contact with an upper end of the conductive pin 41. Note that the protruding portion 32e of the bezel 32 has, at a portion below the through-hole 36t, a through-hole or cutout through which the conductive pin 41 is inserted.

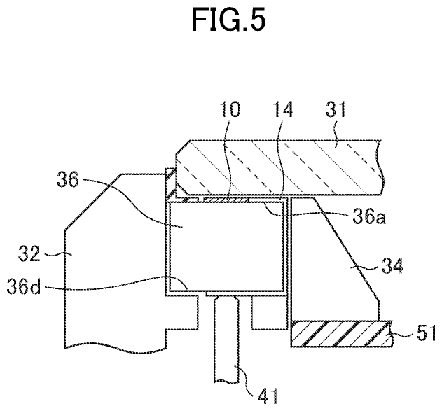

The connection wiring 14 may not be necessarily provided in the through-hole 36t. FIG. 5 is a partial sectional view for illustrating another example of how to connect the antenna electrode 10 and the conductive pin 41. In an example illustrated in FIG. 5, the connection wiring 14 is disposed on the upper surface 36a, the side surface, and a lower surface 36d, of the high dielectric component 36, so as to electrically connect the antenna electrode 10 on the upper surface 36a and the conductive pin 41 that is in contact with the lower surface 36d.

A description is given below of how reception characteristics of the antenna vary depending on components around the antenna electrode 10.

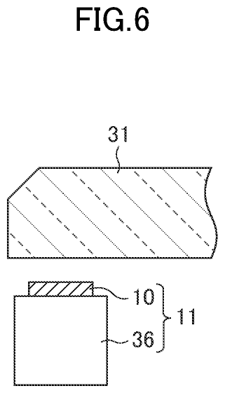

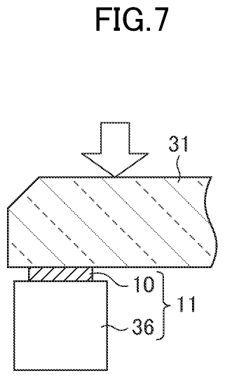

FIG. 6 and FIG. 7 are explanatory views for illustrating a change in distance between the antenna electrode 10 and the high dielectric component 36. In FIG. 6, no external force is applied to the watch glass 31. In FIG. 7, an external force is applied to the watch glass 31. When the watch glass 31 receives an external force applied in a downward direction, there is a risk that the packing 33 or other such components deform, so that the watch glass 31 approaches the antenna electrode 10 to be brought into contact therewith.

The watch glass 31 also has a permittivity, and hence a wavelength of a signal, which can be received by the antenna, is further reduced as a result of the antenna electrode 10 and the watch glass 31 being closer to each other. Consequently, frequency characteristics of the antenna are varied. A wavelength shortening effect considerably owes to not only the watch glass 31 but also dielectric bodies disposed within a distance equal to or less than 1/20 of a reception wavelength from the antenna electrode 10. Regarding those dielectric bodies as well, when their distance from the antenna electrode is slightly changed, the frequency characteristics of the antenna are varied. Conceivable examples of such dielectric bodies include the dial trim ring 34, the dial 51, the bezel 32 forming the outer case, and the movement 59.

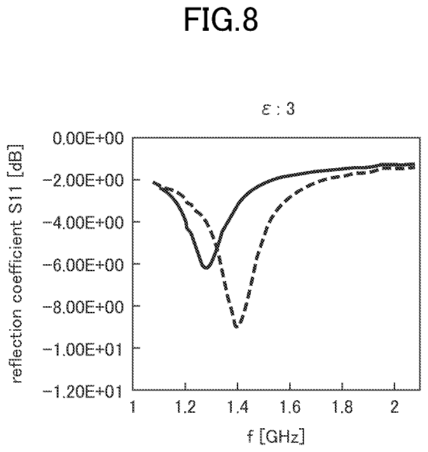

Here, a variation amount of the frequency characteristics changes depending on permittivity of the high dielectric component 36 and the surrounding dielectric body. FIG. 8 is a graph for showing variation in frequency characteristics of the antenna electrode 10 on the dielectric body having a permittivity of 3. The frequency characteristics shown in FIG. 8 are obtained by actual measurement in such a state that an antenna base corresponding to the high dielectric component 36 is, for example, a ring-shaped plastic one, the antenna electrode 10 is disposed on an upper surface of the antenna base, and the sapphire watch glass 31 is provided above the antenna electrode 10. In FIG. 8, sapphire is assumed to have a permittivity of 10.

In FIG. 8, the dashed line indicates a reflection coefficient S11 with respect to a frequency in such a state that the antenna electrode 10 and the antenna base are spaced by 1 mm from the watch glass 31. The minimum value of the reflection coefficient corresponds to a frequency that allows the antenna to receive a signal most efficiently. The solid line of FIG. 8 indicates the reflection coefficient S11 with respect to a frequency in such a state that the antenna electrode 10 and the antenna base are in contact with the watch glass 31. The minimum value of the reflection coefficient corresponds to a frequency (hereinafter referred to as reception frequency) that allows the antenna to receive a signal most efficiently.

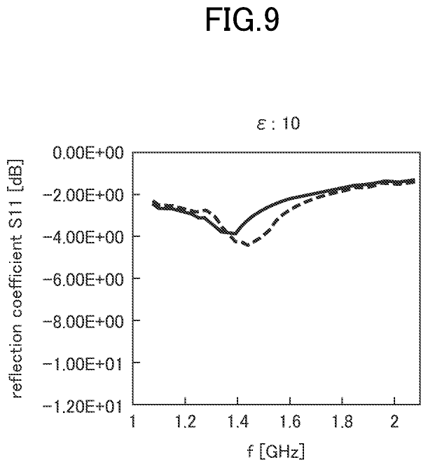

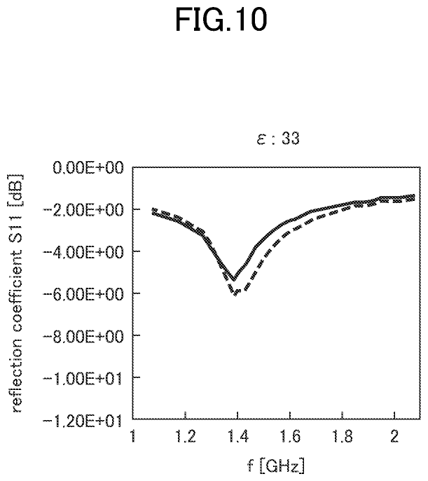

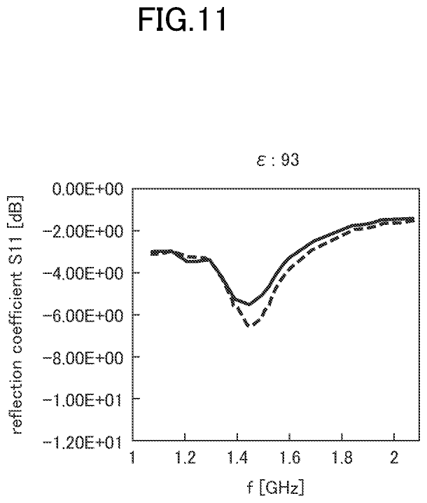

FIG. 9 is a graph for showing variation in frequency characteristics of the antenna electrode 10 on the dielectric body having a permittivity of 10. FIG. 10 is a graph for showing variation in frequency characteristics of the antenna electrode 10 on the dielectric body having a permittivity of 33. FIG. 11 is a graph for illustrating variation in frequency characteristics of the antenna electrode 10 on the dielectric body having a high permittivity of about 90. The dielectric body having the permittivity of 33 is, for example, zirconia. The frequency characteristics shown in FIG. 9 to FIG. 11 are each obtained by actual measurement in such a state that the antenna electrode 10 is disposed on an upper surface of the antenna base, and the sapphire watch glass 31 is provided above the antenna electrode 10. What are indicated by the solid line and the dashed line are the same as those of FIG. 8. Note that, in the illustrated example of FIG. 11, the permittivity is 93, but similar results can be obtained when the permittivity is from about 80 to about 100.

In Table 1, there is shown a change in reception frequency with respect to the permittivity of the antenna base and the distance of the watch glass 31 from the antenna base.

TABLE 1

| | Frequency [GHz] | | | Frequency |
|---|---|---|---|---|
| | Distance | Distance | Frequency | change |
| Permittivity | 0 mm | 1 mm | difference | rate (%) |
| 3 | 1.28 | 1.3981 | 0.1181 | 8.447% |
| 10 | 1.3885 | 1.4327 | 0.0442 | 3.085% |
| 33 | 1.3882 | 1.3886 | 0.0004 | 0.029% |
| 93 | 1.4506 | 1.4538 | 0.0032 | 0.220% |

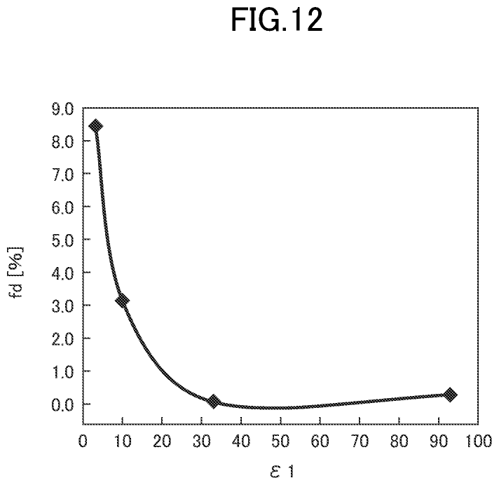

As understood from FIG. 8 to FIG. 11 and Table 1, the antenna base of a higher permittivity tends to have a smaller change in reception frequency, which occurs due to a change in distance. FIG. 12 is a graph for showing a relationship between a permittivity and a frequency change rate fd of the reception frequency. The horizontal axis represents a permittivity of the antenna base, on which the antenna electrode 10 is disposed, and the vertical axis represents the frequency change rate fd of the reception frequency. The frequency change rate fd of the reception frequency is obtained by dividing a difference between a reception frequency measured in such a state that the antenna body 11 and the watch glass 31 have a distance of 1 mm therebetween and a reception frequency measured in such a state that the antenna body 11 and the watch glass 31 are in contact with each other, by the frequency measured in the state that the distance therebetween is 1 mm.

As understood from FIG. 12, the frequency change rate fd of the reception frequency is increased as the antenna base, on which the antenna electrode 10 is disposed, has a permittivity lower than that of any other component adjacent to the antenna electrode 10. Further, the frequency change rate fd of the reception frequency is decreased as the permittivity of the high dielectric component 36 is increased. In particular, when the antenna base has a permittivity more than about twice a permittivity of any other adjacent component, the frequency change rate fd of the reception frequency is small enough to be ignored.

In view of this, when the high dielectric component 36 is formed to have a permittivity equal to or more than twice a permittivity of any other component disposed within a distance equal to or less than 1/20 of the reception frequency from its surrounding component, especially, the antenna electrode 10 (or the antenna body 11), it is possible to suppress an influence of variation in frequency characteristics, which may occur due to deformation or working accuracy during a manufacturing process. More specifically, an influence of variation in frequency characteristics can be suppressed with use of the following structure. That is, the high dielectric component 36 is made of zirconia or a material having a higher permittivity than zirconia. In addition, the dial trim ring 34, the dial 51, the bezel 32 forming the outer case, and the movement 59 are formed to have a permittivity equal to or less than half the permittivity of the high dielectric component 36. Further, the high dielectric component 36 may have a permittivity higher than permittivity of all of the surrounding components as well as the above-mentioned components. The high dielectric base 36 may have a permittivity higher than that of any other component disposed between the watch glass 31 and the movement 59 (e.g., a component adjacent to the antenna electrode 10). In such cases as well, an influence of variation in frequency characteristics can be suppressed.

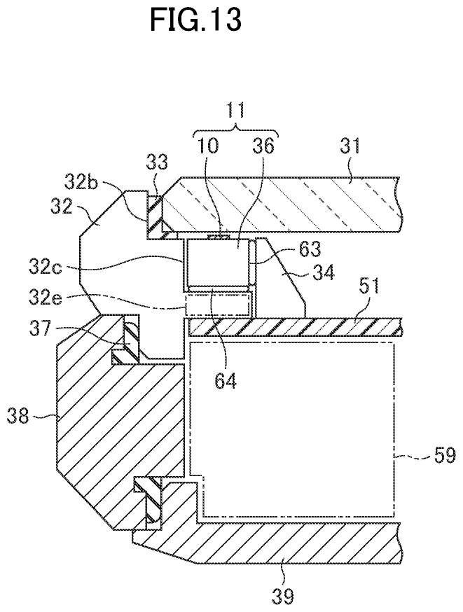

Note that the high dielectric component 36 may be disposed in a different position from that of FIG. 2. FIG. 13 is a partial sectional view for illustrating another example of the satellite radio-controlled wristwatch 1. Unlike the illustrated example of FIG. 2, in the illustrated example of FIG. 13, the bezel 32 has an inner peripheral surface 32b and an inner peripheral surface 32c, which are located outside of the watch glass 31 and the high dielectric component 36, respectively. The inner peripheral surface 32c is provided on an inner side of the inner peripheral surface 32b in plan view. The dial 51 is provided below not only the dial trim ring 34 but also the protruding portion 32e of the bezel 32. In the illustrated example of FIG. 2, the high dielectric component 36 serves to support the watch glass 31 through the packing 33, whereas, in the illustrated example of FIG. 13, the high dielectric component 36 does not support the watch glass 31. When the high dielectric component 36 is made of ceramics, in the illustrated example of FIG. 2, the high dielectric component 36 may suffer from breaking or chipping due to an impact applied via the watch glass 31 or a pressure applied to fit the watch glass 31 thereto. In contrast, in the illustrated example of FIG. 13, the bezel 32 made of metal, for example, holds the watch glass 31, to thereby be able to prevent the problem described above.

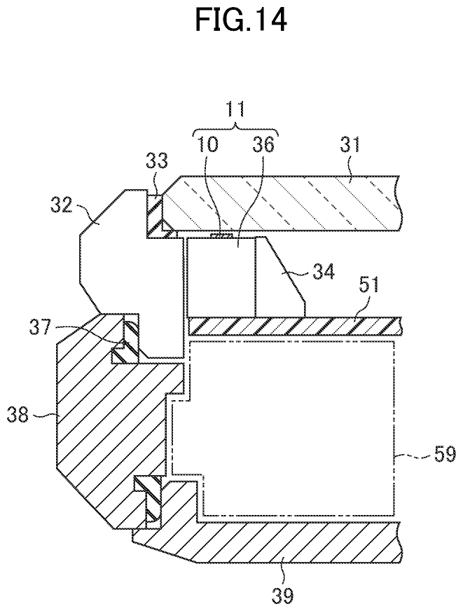

FIG. 14 is a partial sectional view for illustrating another example of the satellite radio-controlled wristwatch 1. Unlike the illustrated example of FIG. 13, in the illustrated example of FIG. 14, the bezel 32 has no protruding portion 32e, and the high dielectric component 36 is disposed directly above the dial 51. In the illustrated example of FIG. 14, the protruding portion 32e is not formed, and hence, when the bezel 32 is made of metal, the antenna electrode 10 can be less influenced by the metal to improve a reception sensitivity. Note that, in the illustrated example of FIG. 14, a projection is formed on an inner peripheral side of the case body 38 so as to hold the movement 59.

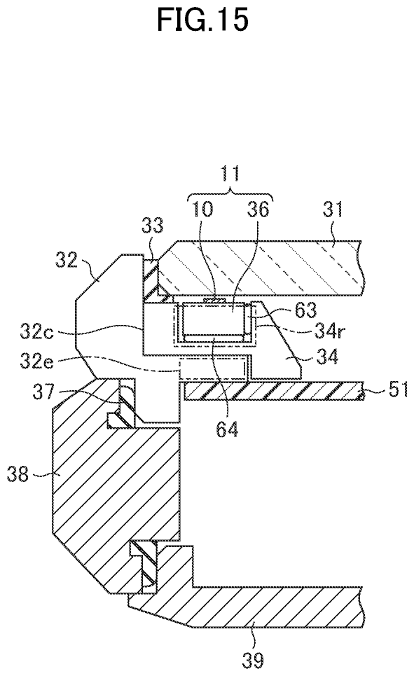

FIG. 15 is a partial sectional view for illustrating another example of the satellite radio-controlled wristwatch 1. Unlike the illustrated example of FIG. 2, in the illustrated example of FIG. 15, the dial trim ring 34 is adjacent to the inner peripheral surface 32c of the bezel 32, and the antenna body 11 is disposed between the dial trim ring 34 and the watch glass 31. More specifically, the antenna body 11 is disposed in a recess 34r formed in an upper surface (surface on the watch glass 31 side) of the dial trim ring 34. Cushioning components 63 and 64 are provided between the dial trim ring 34 and the high dielectric component 36 of the antenna body 11. The cushioning component 63 is disposed on a radially inner side of the high dielectric component 36. The cushioning component 64 is disposed below the high dielectric component 36. In the illustrated example of FIG. 15, the dial trim ring 34 holds the watch glass 31 through the packing 33. For example, when the bezel 32 is made of metal, a large distance is secured between the bezel 32 and the antenna electrode 10 by the dial trim ring 34 located between the high dielectric component 36 and the inner peripheral surface 32c of the bezel 32, so that the reception sensitivity of the antenna electrode 10 can be less influenced by the metal. Meanwhile, regarding the bezel 32 made of ceramics, the dial trim ring 34 is made of plastics, so that the bezel 32 hardly suffers from breaking or chipping when receiving any impact.

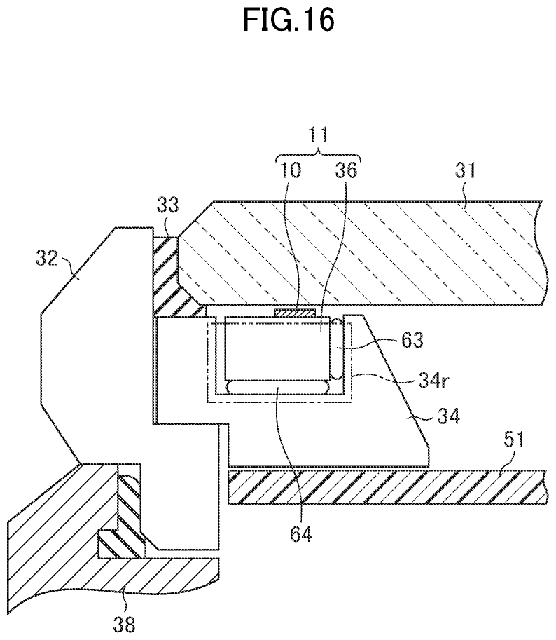

FIG. 16 is a partial sectional view for illustrating another example of the satellite radio-controlled wristwatch 1. Unlike the illustrated example of FIG. 15, in the illustrated example of FIG. 16, the bezel 32 has no protruding portion 32e.

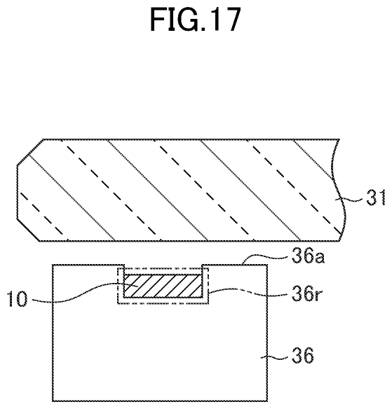

In this example, the high dielectric component 36 may have a recess 36r and the antenna electrode 10 may be disposed in the recess 36r. FIG. 17 is a partial sectional view for schematically illustrating another example of the antenna body 11 and the watch glass 31. In the illustrated example of FIG. 17, the recess 36r is formed in the upper surface 36a of the high dielectric component 36, and the antenna electrode 10 is disposed in the recess 36r. With this arrangement, the high dielectric component 36 is closer to the watch glass 31 or other such components as compared to the antenna electrode 10.

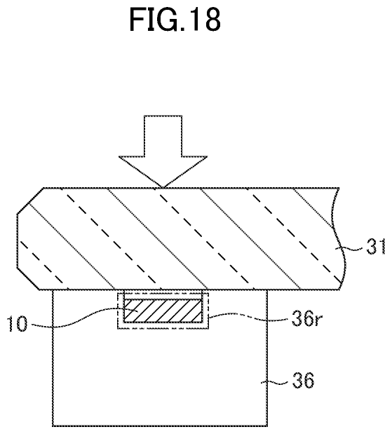

FIG. 18 is a partial sectional view for illustrating an example of how the antenna body 11 and the watch glass 31 of FIG. 17 come close to each other. In the illustrated example of FIG. 18, the watch glass 31 receives an external force and thereby comes close to the antenna body 11. In the illustrated example of FIG. 18, the watch glass 31 and the high dielectric component 36 are in contact with each other, but the antenna electrode 10 and the watch glass 31 are slightly spaced, not being in contact with each other. A wavelength shortening effect of the dielectric body largely varies as a distance between the antenna electrode 10 and any other component is decreased. The recess 36r keeps the requisite minimum distance between the antenna electrode 10 and any other component, and consequently an influence of variation in frequency characteristics can be further suppressed.

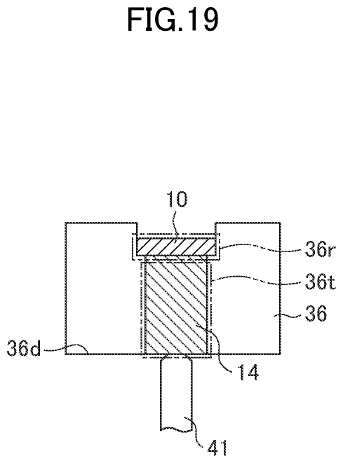

FIG. 19 is a view for schematically illustrating an example of how to connect the antenna body 11 and the conductive pin 41. The high dielectric component 36 has a through-hole 36t directly below an end portion of the antenna electrode 10. The through-hole 36t extends from a bottom portion of the recess 36r to the lower surface 36d of the high dielectric component 36. The metal connection wiring 14 is provided inside the through-hole 36t. The metal connection wiring 14 is brought into contact, at its upper end, with the antenna electrode 10, and is brought into contact, at its lower end, with the upper end of the conductive pin 41. When the wiring is provided on an outer surface of the high dielectric component 36, not inside the through-hole 36t, the wiring may possibly be disconnected, for example, due to an insufficient strength at a bent portion thereof or due to contact with the watch glass 31. The through-hole 36t reduces the risk of the connection wiring 14 being disconnected.

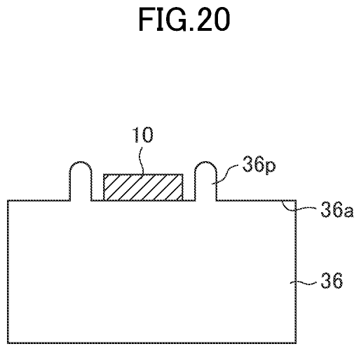

The high dielectric component 36 may have protrusions 36p in place of the recess 36r. FIG. 20 is a partial sectional view for illustrating another example of the antenna body 11. In the illustrated example of FIG. 20, the protrusions 36p are formed in portions adjacent to the antenna electrode 10, of the surface of the high dielectric component 36. In the illustrated example of FIG. 20, the antenna electrode 10 is disposed between the protrusions 36p. The upper end of each protrusion 36p is at a higher position than an upper end of the antenna electrode 10, so that each protrusion 36p is close to a component opposed to the upper surface 36a of the high dielectric component 36 as compared to the antenna electrode 10. The protrusions 36p keep the requisite minimum distance between the antenna electrode 10 and any other component as well, and consequently, an influence of variation in frequency characteristics can be further suppressed.

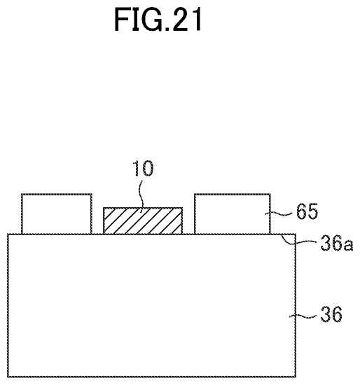

As a substitute for the protrusions 36p, the high dielectric component 36 may have protective components 65 on the surface thereof. FIG. 21 is a partial sectional view for illustrating another example of the antenna body 11. The protective components 65 are arranged on the upper surface 36a of the high dielectric component 36 so as to surround the antenna electrode 10. An upper end of each protective component 65 is at a position higher than the upper end of the antenna electrode 10, so that the protective components 65 are close to a component opposed to the upper surface 36a of the high dielectric component 36 as compared to the antenna electrode 10. The protective components 65 are nonconductive ones. A material for the protective components 65 has a permittivity lower than that of the high dielectric component 36, and is less liable to be deformed. In the illustrated example of FIG. 21 as well, variation in frequency characteristics, which may occur due to, for example, deformation, can be suppressed by securing the requisite minimum distance between the antenna electrode 10 and any other component.

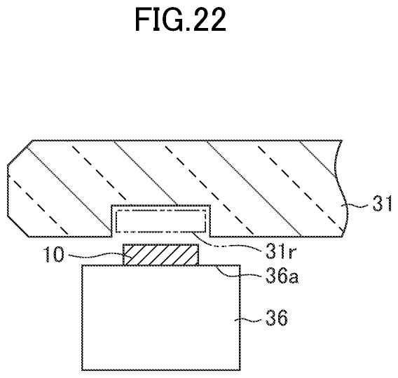

A recess 31r or protrusions 31p, for example, may be formed in the watch glass 31 or other such component opposed to the high dielectric component 36, not in the high dielectric component 36. FIG. 22 is a partial sectional view for illustrating another example of the antenna body 11 and a component opposed to the antenna body 11. In the illustrated example of FIG. 22, the upper surface 36a of the high dielectric component 36 has none of the recess 36r, the protrusions 36p, and the protective components 65. Instead, the watch glass 31 opposed to the high dielectric component 36 and the antenna electrode 10 has a recess 31r conforming to a shape of the antenna electrode 10. The recess 31r is formed in a region opposed to the antenna electrode 10 to have a depth larger than the thickness of the antenna electrode 10. With this arrangement, even when the watch glass 31 is brought into contact with the high dielectric component 36, the requisite minimum distance is kept between the antenna electrode 10 and the watch glass 31, to thereby be able to suppress variation in frequency characteristics, which may occur due to, for example, deformation.

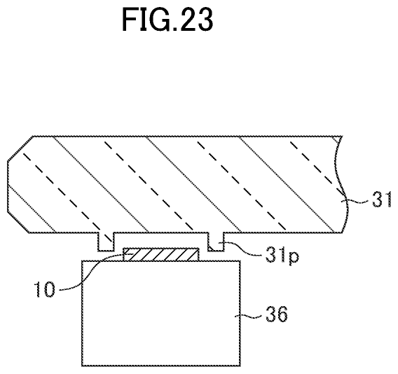

FIG. 23 is a partial sectional view for illustrating another example of the antenna body 11 and a component opposed to the antenna body 11. In the illustrated example of FIG. 23, the watch glass 31 opposed to the high dielectric component 36 and the antenna electrode 10 has protrusions 31p. The protrusions 31p are formed in portions opposed to a region around the antenna electrode 10, of the surface of the watch glass 31. The protrusions 31p are not opposed to the antenna electrode 10, and the length of each protrusion 31p is larger than the thickness of the antenna electrode 10. With this arrangement, even when the watch glass 31 is brought into contact with the high dielectric component 36, the requisite minimum distance can be kept between the antenna electrode 10 and the watch glass 31, thereby being capable of suppressing variation in frequency characteristics, which may occur due to, for example, deformation.

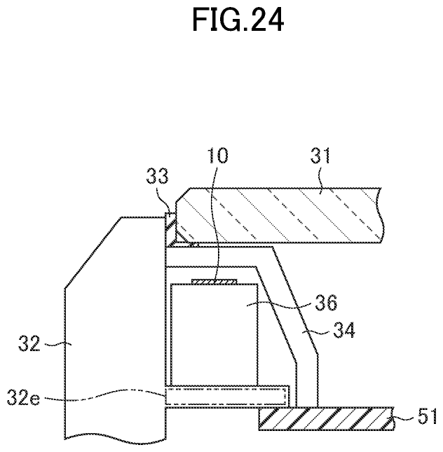

A description is given below of an example in which a component opposed to the antenna electrode 10 is the dial trim ring 34. FIG. 24 is a partial sectional view for illustrating another example of the satellite radio-controlled wristwatch 1. Unlike the illustrated example of FIG. 2, in the illustrated example of FIG. 24, the dial trim ring 34 also covers an upper portion of the antenna body 11, and the antenna body 11 is disposed in a space surrounded by the dial trim ring 34 and the bezel 32. The dial trim ring 34 is opposed to the antenna electrode 10. The dial trim ring 34 is made of, for example, a resin, and has a permittivity of from about 2 to about 5. In the illustrated example of FIG. 24 as well, the high dielectric component 36 is formed to have a permittivity more than twice permittivity of the surrounding components such as the bezel 32, the dial trim ring 34, and the watch glass 31, so that variation in frequency characteristics can be suppressed.

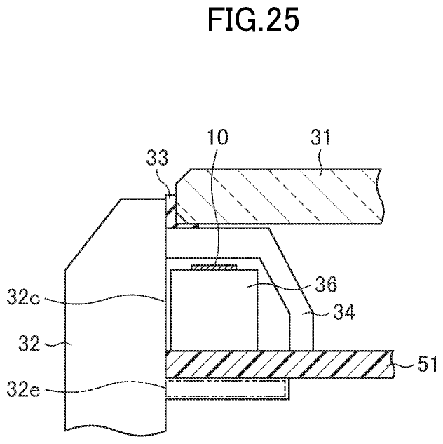

FIG. 25 is a partial sectional view for illustrating another example of the satellite radio-controlled wristwatch 1. Unlike the illustrated example of FIG. 24, in the illustrated example of FIG. 25, an outer periphery of the dial 51 is adjacent to the inner peripheral surface 32c of the bezel 32 in plan view. Further, the protruding portion 32e of the bezel 32 is located below an outer peripheral portion of the dial 51, and the high dielectric component 36 is disposed above the outer peripheral portion thereof. In the illustrated example of FIG. 25 as well, variation in frequency characteristics can be suppressed.

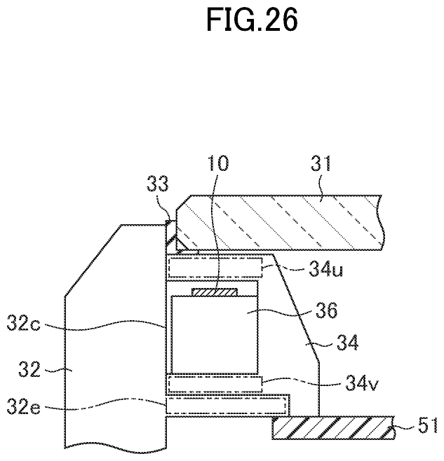

FIG. 26 is a partial sectional view for illustrating another example of the satellite radio-controlled wristwatch 1. Unlike the illustrated example of FIG. 24, in the illustrated example of FIG. 26, the dial trim ring 34 has an upper protruding portion 34u and a lower protruding portion 34v, which are adjacent to the inner peripheral surface 32c of the bezel 32. Further, the antenna body 11 is sandwiched between the upper protruding portion 34u and the lower protruding portion 34v. In the illustrated example of FIG. 26 as well, variation in frequency characteristics can be suppressed.

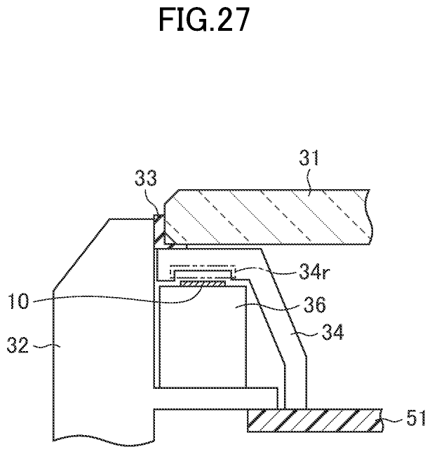

FIG. 27 is a partial sectional view for illustrating another example of the satellite radio-controlled wristwatch 1. Unlike the illustrated example of FIG. 24, in the illustrated example of FIG. 27, the dial trim ring 34 has, in its surface portion opposed to the antenna electrode 10, a recess 34r. The recess 34r has a shape conforming to the antenna electrode 10. The recess 34r is formed in a region opposed to the antenna electrode 10 to have a depth larger than the thickness of the antenna electrode 10. With this structure, even when the dial trim ring 34 is brought into contact with the high dielectric component 36, the requisite minimum distance can be secured between the antenna electrode 10 and the dial trim ring 34, thereby being capable of suppressing variation in frequency characteristics, which may occur due to, for example, deformation. Note that the dial trim ring 34 may have protrusion(s) opposed to a region around the antenna electrode 10 in place of the recess 34r.

Further, the high dielectric component 36 may be disposed below the dial 51 or disposed directly on the protruding portion 32e of the bezel 32. As another possible arrangement, the dial 51 and the protruding portion 32e may not be provided below the high dielectric component 36, and the high dielectric component 36 may be directly disposed on the main plate in the movement 59. When the high dielectric component 36 is directly disposed on the main plate, a wiring from the circuit board in the movement 59 may be provided on the main plate, and brought into direct contact with the connection wiring 14 in the high dielectric component 36. Moreover, the wiring from the circuit board and the connection wiring 14 may be joined together through use of a conductive adhesive such as a solder.

In the above-mentioned examples, the antenna electrode 10 may be disposed opposite to the inner peripheral surface 32c of the bezel 32 forming the outer case. In this case, when the high dielectric component 36 is particularly formed to have a permittivity equal to or more than twice a permittivity of the bezel 32, variation in frequency characteristics can be suppressed.

Descriptions are now made of examples in which the antenna electrode 10 is provided on the surface of the bezel 32, while focusing on the difference from other examples. In the following examples, the bezel 32 is made of ceramics having a permittivity of around 32.

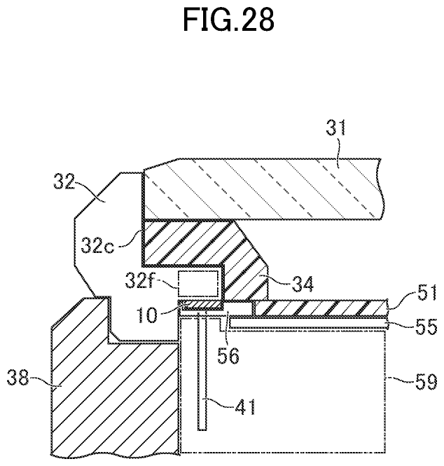

FIG. 28 is a partial sectional view for illustrating another example of the satellite radio-controlled wristwatch 1. The bezel 32 has a protruding portion 32f that protrudes radially inward from a lower portion of the inner peripheral surface 32c. The inner peripheral surface 32c is opposed to a side surface of the watch glass 31. The protruding portion 32f has a ring shape. The antenna electrode 10 is disposed on a lower surface thereof. A portion corresponding to a feeding point of the antenna electrode 10 is in contact with a feeding pin 41 extending in the up-down direction.

Further, a peripheral edge of the dial 51 is located below the dial trim ring 34, and a solar cell retaining component 56 is disposed between an outer peripheral edge of the dial 51 and an inner periphery of the bezel 32 located below the protruding portion 32f. A solar cell 55 is disposed below the dial 51 and the solar cell retaining component 56. The solar cell 55 is disposed between the movement 59 and the dial 51. The solar cell retaining component 56 secures the solar cell 55 in position as well as prevents the solar cell 55 from turning. Alternatively, the solar cell retaining component 56 may secure the dial 51 in position as well as prevent the dial 51 from turning. The solar cell retaining component 56 is adjacent to the antenna electrode 10.

The solar cell retaining component 56 is a nonconductive component having a permittivity lower than that of the bezel 32, on which the antenna electrode 10 is disposed. The solar cell retaining component 56 has a recess conforming to a shape of the antenna electrode 10, and the antenna electrode 10 is disposed in the recess. The antenna electrode 10 may be in contact with any adjacent component (in this example, the solar cell retaining component 56), or the antenna electrode 10 may be spaced from the adjacent component. In the latter case, the structure used to keep a certain distance between the antenna electrode 10 and the adjacent component is provided. For example, the solar cell retaining component 56 has a shape conforming to the bezel 32, and is secured in position through contact with the bezel 32.

In the illustrated example of FIG. 28, the antenna electrode 10 is disposed on the surface of the bezel 32. In this example, the bezel 32 has the highest permittivity out of components around the antenna electrode 10, specifically, components disposed within a distance equal to or less than 1/20 of the reception wavelength, from the antenna electrode. Moreover, the bezel 32 has the highest permittivity out of components disposed between the movement 59 and the watch glass 31 (or components closer to the watch glass than the movement 59). With this structure, variation in frequency characteristics of the satellite radio-controlled wristwatch 1 can be suppressed.

Note that the dial trim ring 34 may be integrated with the solar cell retaining component 56 so as to serve as the solar cell retaining component 56, or the upper surface of the movement 59 may function as the solar cell retaining component 56.

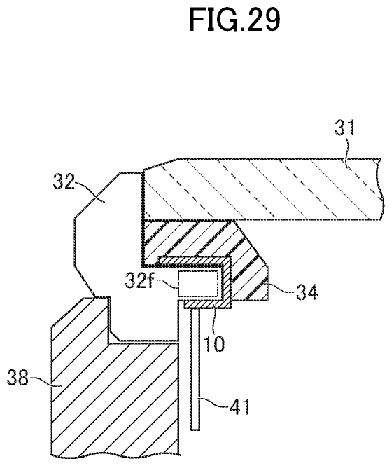

FIG. 29 is a partial sectional view for illustrating an other example of the satellite radio-controlled wristwatch 1. Unlike the illustrated example of FIG. 28, in the illustrated example of FIG. 29, the antenna electrode 10 is disposed on an upper surface of the protruding portion 32f of the bezel 32. Further, the antenna electrode 10 has a wiring-like portion extending from the upper surface of the protruding portion 32f via an inner peripheral surface thereof to a lower surface thereof. The antenna electrode 10 is in contact with the conductive pin 41 extending in the up-down direction, at a portion below the protruding portion 32f. The dial trim ring 34 is opposed to a portion of the antenna electrode 10. The portion of the antenna electrode 10 is on the upper surface of the protruding portion 32f and a portion on the inner peripheral surface. The dial trim ring 34 has a recess conforming to those portions.

In the illustrated example of FIG. 29 as well, the antenna electrode 10 is disposed on the surface of the bezel 32. Further, the bezel 32 has the highest permittivity out of components around the antenna electrode 10 or components disposed between the movement 59 and the watch glass 31. In addition, even when the case body 38 is made of metal, a distance between the case body 38 and the antenna electrode 10 can be larger than the illustrated one of FIG. 28. Hence, the antenna sensitivity can be further improved. Note that the dial trim ring 34 serves to hide the antenna electrode 10 from a user's view, and aesthetic properties are ensured thereby.

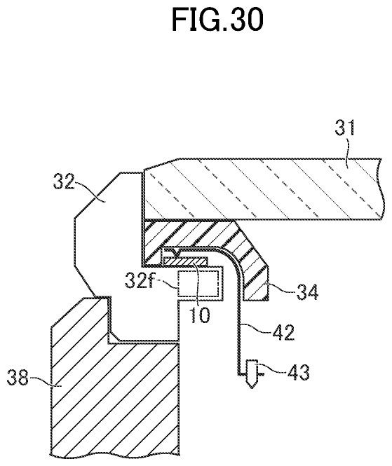

FIG. 30 is a partial sectional view for illustrating an other example of the satellite radio-controlled wristwatch 1. Unlike the illustrated example of FIG. 29, in the illustrated example of FIG. 30, the antenna electrode 10 is disposed only on the upper surface of the protruding portion 32f of the bezel 32. Further, a portion corresponding to a feeding point, of the upper surface of the antenna electrode 10 is in contact with an end portion of a connection electrode 42, which has a flat spring structure. An upper portion of the end portion of the connection electrode 42 is in contact with the dial trim ring 34, and the end portion is sandwiched between the dial trim ring 34 and the antenna electrode 10. The connection electrode 42 is connected by means of a screw 43 to a circuit board on which a reception circuit, for example, is mounted. The dial trim ring 34 has a recess conforming to shapes of the antenna electrode 10 and the connection electrode 42.

Unlike the illustrated example of FIG. 29, in the illustrated example of FIG. 30, the antenna electrode 10 is not required to be formed on a plurality of surfaces of the protruding portion 32f. Moreover, the flat spring can substitute for the feeding pin 41. With this arrangement, a manufacturing cost for the satellite radio-controlled wristwatch 1 can be further reduced.

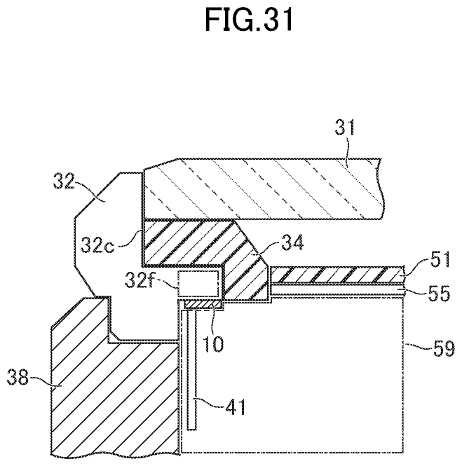

FIG. 31 is a partial sectional view for illustrating an other example of the satellite radio-controlled wristwatch 1. Unlike the illustrated example of FIG. 28, in the illustrated example of FIG. 31, the dial 51 and the solar cell 55 are disposed at a position higher than the antenna electrode 10. In addition, the solar retaining component 56 is not provided, and the solar cell 55 is sandwiched between the movement 59 and the dial 51. Further, the lower surface of the antenna electrode 10 is adjacent to an outer peripheral side portion of the upper surface of the movement 59. In the illustrated example of FIG. 31 as well, the bezel 32 has the highest permittivity out of components around the antenna electrode 10, specifically, components disposed within a distance equal to or less than 1/20 of the reception wavelength from the antenna electrode. Further, when the bezel 32 is formed to have the highest permittivity out of components disposed between the movement 59 and the watch glass 31, the same effects as those in the illustrated example of FIG. 28, for example, can be obtained.

A case, in which the present invention is applied to the satellite radio-controlled wristwatch 1, has been described so far, but the present invention is also applicable to, for example, a portable small-sized watch that is not a wristwatch.

The invention claimed is:

1. A radio-controlled watch, comprising:
a watch glass;
a case, into which the watch glass is fitted;
a movement disposed inside the case; and
an antenna body, at least a part of which is disposed between the watch glass and the movement and at least part of which is also disposed along an inner periphery of the case,
the antenna body including:
an antenna electrode; and
an antenna base having a surface on which the antenna electrode is disposed, and
the antenna base having a permittivity higher than a permittivity of other components around the antenna body.

2. The radio-controlled watch according to claim 1, wherein the permittivity of the antenna base is higher than permittivity of other components disposed within a distance equal to or less than 1/20 of a reception wavelength away from the antenna body.

3. The radio-controlled watch according to claim 1, wherein the permittivity of the antenna base is more than twice the permittivity of the other components.

4. The radio-controlled watch according to claim 1, wherein the permittivity of the antenna base is higher than the permittivity of other components disposed between the watch glass and the movement.

5. The radio-controlled watch according to claim 1, wherein the permittivity of the antenna base is higher than permittivity of other components adjacent to the antenna body.

6. The radio-controlled watch according to claim 1, wherein one of the other components is opposed to at least a part of the antenna electrode.

7. The radio-controlled watch according to claim 1, wherein the antenna base has a portion closer to a second component than the antenna electrode.

8. The radio-controlled watch according to claim 7,
wherein the antenna base has one of a recess and a plurality of protrusions, and
wherein the antenna electrode is disposed inside the recess, or disposed adjacent to the plurality of protrusions.

9. The radio-controlled watch according to claim 7, further comprising a protective component disposed on the surface of the antenna base and also around the antenna electrode.

10. The radio-controlled watch according to claim 7, wherein the second component has one of a recess conforming to a shape of the antenna electrode, and a protrusion opposed to a region around the antenna electrode, of a surface of the antenna base.

11. The radio-controlled watch according to claim 1, further comprising a protective component having elasticity, the protective component being disposed on the movement side of the antenna body.

12. The radio-controlled watch according to claim 1, further comprising:
a dial trim ring disposed between the watch glass and the movement,
the antenna body being disposed between the dial trim ring and the watch glass.

13. The radio-controlled watch according to claim 12,
wherein the dial trim ring has a recess in a surface thereof on a side of the watch glass, and
wherein the antenna body is disposed in the recess.

14. The radio-controlled watch according to claim 1,
wherein the any other watch components comprise a dial trim ring disposed between the watch glass and the movement, the watch glass, a dial disposed between the watch glass and the movement, the case, and the movement, and
wherein the dial trim ring is closer to the watch glass than the antenna body.
